(19) United States
(12) Patent Application Publication
(10) Pub. No.: US 2016/0078192 A1
(43) Pub. Date: Mar. 17, 2016

(54) PROCESSING MEDICAL DATA ON A CLOUD SERVER

(71) Applicant: Tai Seng Chen, San Jose, CA (US)

(72) Inventor: Tai Seng Chen, San Jose, CA (US)

(73) Assignee: CASSIA NETWORKS, San Jose, CA (US)

(21) Appl. No.: 14/852,372

(22) Filed: Sep. 11, 2015

Related U.S. Application Data
(60) Provisional application No. 62/048,870, filed on Sep. 11, 2014.

(51) Int. Cl. G06F 19/00; G06N 99/00; G06N 5/04

(52) U.S. Cl. CPC G06F 19/3418; G06N 5/048; G06N 5/046; G06N 99/005

(57) ABSTRACT

The system includes a cloud server computer configured to receive at least two sets of raw data from at least two sensors carried by the user. Further, cloud server computer configured to process the at least two sets of raw data using a fuzzy set classifier to obtain a fuzzy set corresponding to each of the at least two sets of raw data. Yet further, the cloud server computer configured to combine the fuzzy sets corresponding to the at least two sets of raw data using a rule based processor to determine severity level for the user. Moreover, the cloud server computer configured to send an alert based on the determined severity level.

### CROSS-REFERENCE TO RELATED APPLICATIONS

This application claims priority from a provisional patent application No. 62/048,870, filed on Sep. 11, 2014, which is incorporated herein by reference in its entirety.

### FIELD OF THE INVENTION

Generally, the disclosure relates to a system for remote medical data collection at a cloud server. More specifically, the disclosure relates to a cloud server configured to receive and process medical data from a set of wearable medical devices.

### BACKGROUND

Traditionally, the standard medical care and practice involves more frequent visits to a physician's office where the vital signs of a patient are measured and then conclusions are drawn based on the measurements. This practice is inefficient and often leads to situations where physicians do not have the required data to draw the right conclusions.

Therefore, wearable sensors are becoming more popular. These small, comfortable, and nonintrusive devices are capable of monitoring patients vital signs remotely and continuously, while they go about their daily activities. The data collected allows physicians to reach a more realistic and accurate diagnosis, which reduces the expensive hospital re-admission rates for patients after surgery. For heart patients, the re-admission rates may fall by about 20%. The Medicare spent for the unplanned readmission in one year is about $17 billion, which is about 20% of all Medicare payments. The 30-day readmission rate for heart attacks is 19.97% nationwide. This leads to considerable losses to the exchequer.

Further, it is difficult to deal with imprecise medical diagnosis using traditional data management system based on Boolean logic, which allows for only two options true or false. The medical data is inherently fuzzy, so the Boolean logic often fails. This leads to triggering of too many alerts in a clinical environment, which may overwhelm caregivers and lead to missing truly significant alerts.

Sensors with threshold based alerts are also limited by the fact that each sensor is not aware of the information provided by other sensors. Sensors do not have access to other information in the patient's medical record or attending physician's knowledge of patient's present state of health. As a result, caregivers alert fatigue is a major problem caused by numerous reported false alerts.

A new and improved system is desired that collects medical data remotely, continuously and generates smart's when required.

### SUMMARY

The system includes a cloud server computer configured to receive at least two sets of raw data from at least two sensors carried by the user. Further, cloud server computer configured to process the at least two sets of raw data using a fuzzy set classifier to obtain a fuzzy set corresponding to each of the at least two sets of raw data. Yet further, the cloud server computer configured to combine the fuzzy sets corresponding to the at least two sets of raw data using a rule based processor to determine severity level for the user. Moreover, the cloud server computer configured to send an alert based on the determined severity level.

According to some embodiments, a method for monitoring health condition of a user is disclosed. The method includes receiving at least two sets of raw data from at least two sensors carried by the user, processing the at least two sets of raw data to obtain a fuzzy set corresponding to each of the at least two sets of raw data, combining the fuzzy sets corresponding to the at least two sets of raw data to determine severity level for the user and sending an alert based on the determined severity level.

According to a further embodiment, the system includes a cloud server and a set of smart sensors or wearable medical devices for monitoring heart patients in their homes. The cloud server includes a learning logic engine (LLE) which comprises a series of software modules of learning logic algorithms for remotely monitoring health of patients using data obtained from multiple sensors. The learning logic algorithms include pattern recognition algorithms and fuzzy logic classification methods derived from neural science. Further the LLE employs a rule-based approach to determine severity level for a user. The use of fuzzy set classification tables and rules table helps in decreasing the number of false alerts. Alert management is extremely important to a sustainable success to the proposed system.

According to other embodiments, the disclosed system takes individual user differences into account based on the caregiver's knowledge of the user's medical record and the user's baseline vital signs. The caregivers may also configure the system for a given user to fine tune alerts for each user.

According to a further embodiment, the raw data collected from thousands of users is kept separate from processed data and stored in the cloud for future medical research.

### BRIEF DESCRIPTION OF DRAWINGS

FIG. 1 illustrates an environment in which an embodiment of the present invention operates.

FIG. 2 is a block diagram of a system for processing medical data, in accordance with an embodiment.

FIG. 3 illustrates a flowchart of a method for processing medical data, in accordance with an embodiment.

FIG. 4A illustrates a fuzzy set classification table, in accordance with an embodiment.

FIG. 4B illustrates a fuzzy set classification table, in accordance with an embodiment.

FIG. 4C illustrates a rules table for combining the fuzzy set classifications, in accordance with an embodiment.

FIG. 5 is a functional block diagram of a system for processing medical data, in accordance with an embodiment.

FIG. 6 illustrates an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary.

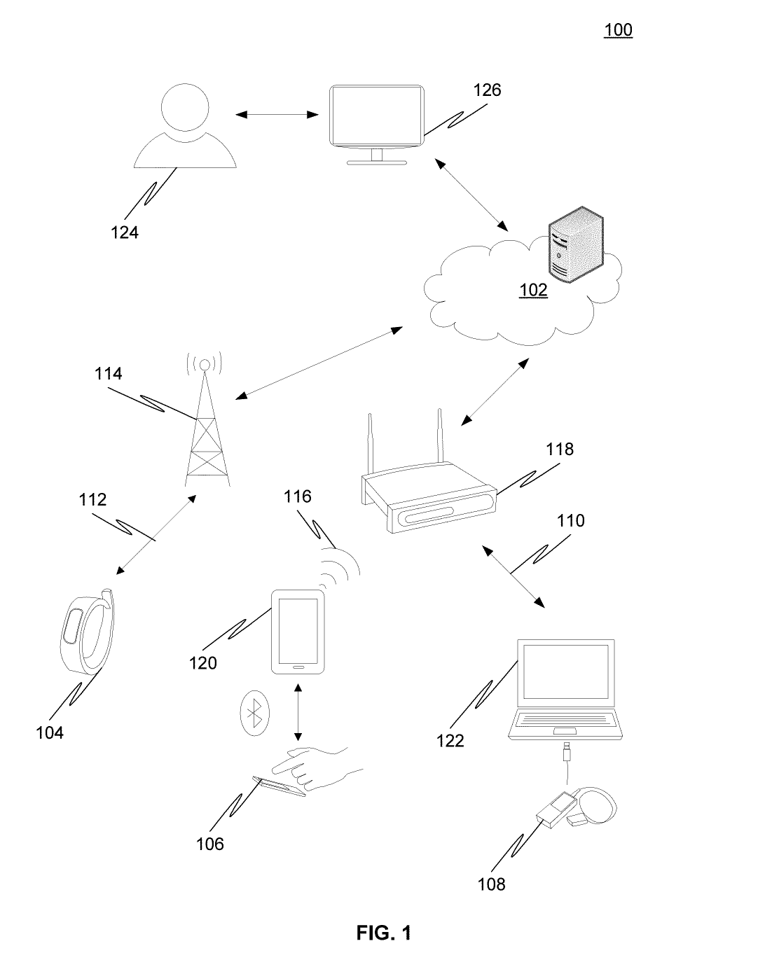

The present invention will be further illustrated with examples below. Referring first to FIG. 1 illustrating an environment 100 in which an embodiment of the present invention operates. The environment 100 includes a cloud server 102 configured to receive medical data from user sensors 104, 106 and 108 over the internet. The sensors 104-108 may be small single-function consumer devices designed for portability and convenience. For example, the sensor 104 may be a wearable medical device, the sensor 106 may be a heart rate (HR) reader and the sensor 108 may be a Blood Pressure (BP) monitoring device. Further, the data flow may be bidirectional, wherein software updates, test settings and setup conditions may be downloaded from the cloud server 102 at the sensors 104-108. The cloud server 102 may connect to the sensors 104-108 via Internet through a wired connection 110, a wireless connection including a cell phone connection 112 (via a cell tower 114) or a Wi-Fi connection 116 (via a modem 118).

The sensors 104-108 are configured to continuously measure vital signs including, but not limited to, BP, HR, blood oxygen saturation level (SpO2), and respiration rate (RR).

Further, the sensors 104-108 may communicate directly with the cloud server 102 (for example, the sensor 104), or they may communicate wirelessly through a smartphone 120 (for example, the sensor 106) or a computer 122 (for example, the sensor 108).

A caregiver 124 is able to access the cloud server 102 using secure access from a computer 126. The caregiver may remotely monitor users' health, interact with users, receive alerts and respond to various alerts.

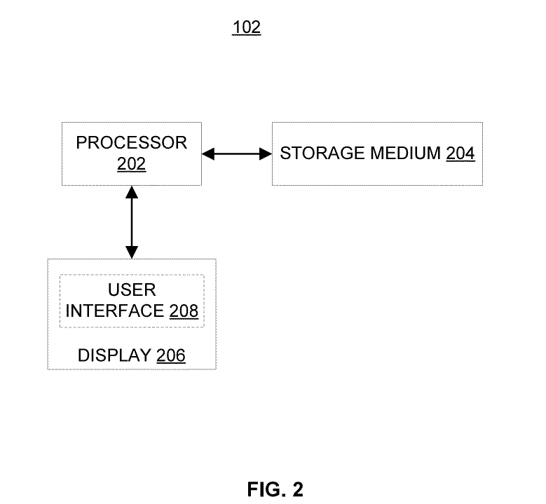

Now, referring to FIG. 2, the cloud server 102 for processing medical data is illustrated in accordance with an embodiment. In particular, the cloud server is configured to process medical data received from remotely located sensors (for example, the sensors 104-108). The cloud server 102 includes one or more processors (for example, a processor 202), a storage medium (e.g., a memory) 204, and a display 206 (optional). Storage medium 204 stores instructions that, when executed by one or more processors 202, cause one or more processors 202 to process medical data received from the remotely located sensors in accordance with various embodiments. In an embodiment, storage medium 204 may be a computer readable medium. The cloud server 102 interacts with users via a user interface 208 accessible to the users via display device 206. To facilitate system interoperability, HL7/IEEE11073 standard is used for data exchange between the cloud server 102, the remotely located sensors and other devices.

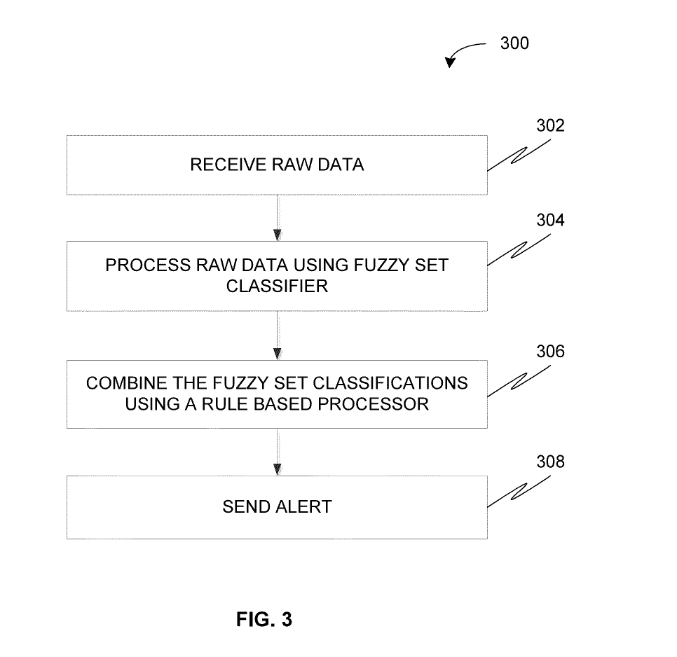

FIG. 3 illustrates a flowchart 300 of a method for processing medical data, in accordance with an embodiment. The sensors 104-108 capture medical data (raw data) and send the same to the cloud server 102 via Internet. At 302, the cloud server 102 receives the raw data sent by the two or more sensors 104-108. For example, raw data from a HR reader may be a series of numbers representing the value of heart beat, along with the time at which each measurement was made.

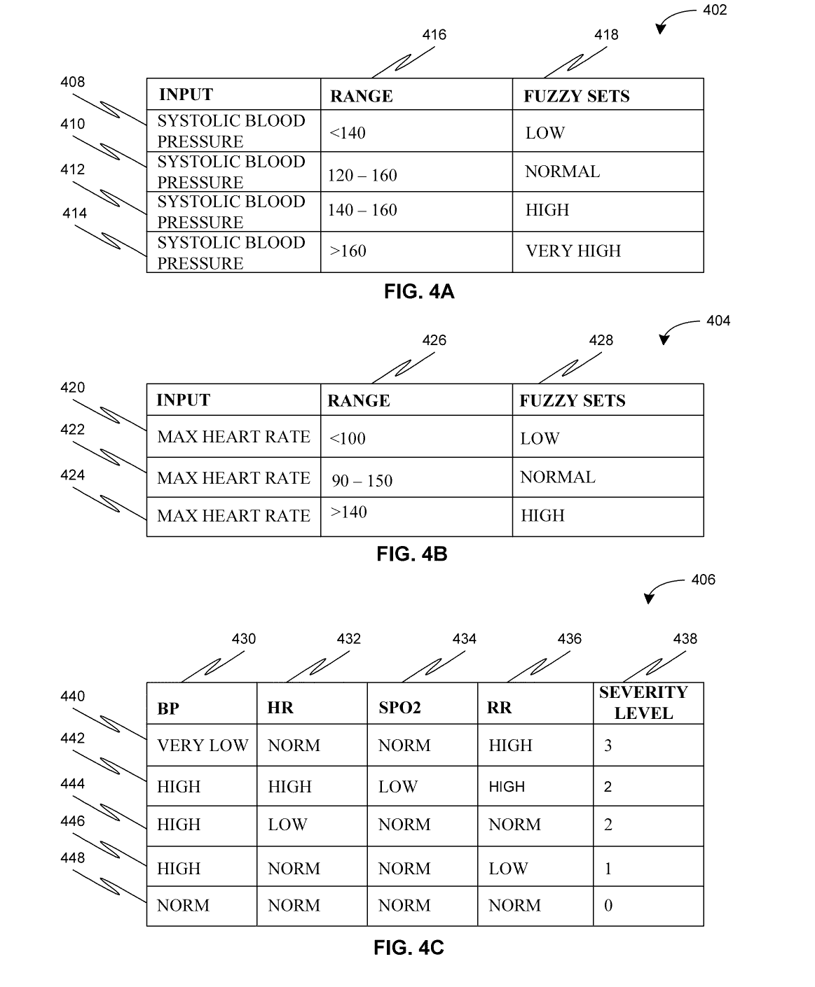

Thereafter, at 304, the cloud server 102 performs fuzzy set classification for the received raw data from each of the two or more sensors 104-108 to obtain two or more fuzzy sets. The fuzzy set classification helps to cope with uncertainties, to make fuzzy inferences and to make decisions. The fuzzy set classification is performed using a fuzzy set classification table which defines fuzzy sets for various ranges the raw data. The fuzzy set classification table for a certain parameter may be obtained based on scientific literature. Further, a literature survey may be conducted wherein domain medical experts provide the set of ranges for the fuzzy set classification table. Yet further, caregivers may modify the fuzzy set classification table based on user's medical history. Further, the cloud server 102 provides an easy to use User Interface (UI) that allows caregivers to modify fuzzy set classification table to address a specific user and modify range values without rewriting the entire table. For example, a fuzzy set classification table 402 for BP is shown in FIG. 4A and a fuzzy set classification table 404 for HR is shown in FIG. 4B.

Next, at 306, the cloud server 102 combines the two or more fuzzy sets based on a rules set, which may be defined in a rules table. The rules table defines combinations of various fuzzy sets and a corresponding severity level. An example of a rule table 406 is shown in FIG. 4C. Combining fuzzy sets (corresponding to vital signs) in this way greatly reduces the number of false alerts generated. It also reduces the number of unnecessary and expensive procedures performed based on false alerts.

Further, classification of vital signs using fuzzy sets also makes it easy to establish a rule set customized to each user's baseline vital signs. A user's baseline record is established by continuously recording data for specific initial time duration, say 48 hours.

Finally, at 308, the cloud server 102 raises an alert based on the severity level of the health condition of a user determined using the rules table.

FIG. 4A illustrates the fuzzy set classification table 402 corresponding to systolic BP, in accordance with an embodiment. The table 402 includes four rows, i.e., a row 408, a row 410, a row 412 and a row 414. Each of these four rows corresponds to a range of values of systolic BP and a corresponding fuzzy set. Further, the table 402 includes 2 columns, i.e., a column 416 and a column 418. The column 416 lists the various range of values and the column 418 lists various fuzzy sets.

For example, the row 408 corresponds to a range of values less than 140 and the related fuzzy set is defined as “Low”. The row 410 corresponds to a range of values between 120 and 160 and the related fuzzy set is defined as “Normal”. The row 412 corresponds to a range of values between 140 and 160 and the related fuzzy set is defined “High”. The row 414 corresponds to a range of values more than 160 and the related fuzzy set is defined as “Very High”.

FIG. 4B illustrates the fuzzy set classification table 404 corresponding to maximum HR, in accordance with an embodiment. The table 404 includes three rows, i.e., a row 420, a row 422, and a row 424. Each of these three rows corresponds to a range of values of HR and a corresponding fuzzy set. Further, the table 404 includes 2 columns, i.e., a column 426 and a column 428. The column 426 lists the various range of values and the column 428 lists various fuzzy sets.

For example, the row 420 corresponds to a range of values less than 100 and the related fuzzy set is defined as “Low”. The row 422 corresponds to a range of values between 90 and 150 and the related fuzzy set is defined as “Normal”. The row 424 corresponds to a range of values more than 140 and the related fuzzy set is defined as “High”.

FIG. 4C illustrates the rules table 406 for combining the fuzzy set classifications for 4 vital signs BP, HR, SpO2, and RR, in accordance with an embodiment. The table 404 includes four columns corresponding to the 4 vital signs as mentioned in the column header, i.e., a column 430 corresponding to BP, a column 432 corresponding to HR, a column 434 corresponding to SpO2 and a column 436 corresponding to HR. The table 406 further includes a column 438 corresponding to “Severity Level”.

Further, the table 404 includes 5 rows 440-448, each row providing a combination of fuzzy sets for BP, HR, SpO2 and RR for a user at a particular time. For example, the row 440 provides fuzzy sets “Very Low”, “Norm”, “Norm”, and “High” for BP, HR, SpO2 and RR respectively. The corresponding severity level is “3”. The row 442 provides fuzzy sets “High”, “High”, “Low”, and “High” for BP, HR, SpO2 and RR respectively. The corresponding severity level is “2”. The row 444 provides fuzzy sets “High”, “Low”, “Norm”, and “Norm” for BP, HR, SpO2 and RR respectively. The corresponding severity level is “2”. The row 446 provides fuzzy sets “High”, “Norm”, “Norm”, and “Low” for BP, HR, SpO2 and RR respectively. The corresponding severity level is “1”. The row 448 provides fuzzy sets “Norm”, “Norm”, “Norm”, and “Norm” for BP, HR, SpO2 and RR respectively. The corresponding severity level is “0”.

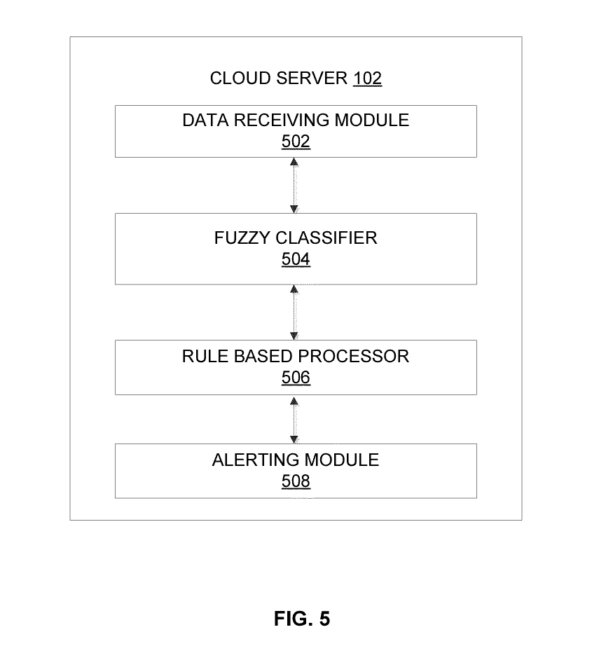

FIG. 5 is a functional block diagram of the cloud server 102 implemented by the system elements explained in conjunction with FIG. 3 above, in accordance with an embodiment. The cloud server 102 includes a Learning logic engine (LLE) which comprises a series of software modules of learning logic algorithms for remotely monitoring health of users. The learning logic algorithms include pattern recognition algorithms and Fuzzy logic classification methods derived from neural science.

In an exemplary embodiment, the cloud server 102 includes a data receiving module 502, a fuzzy classifier 504, a rule-based processor 506, and an alerting module 508. The various modules work together to process medical data.

In an exemplary embodiment, a user is suffering from heart disease. Accordingly, the caregiver recommends the user to use 4 sensors (wearable health monitors) to monitor 4 vital signs, namely, BP, HR, Sp02, and RR. SpO2 is an early indicator of heart attack when blood is not flowing through the lungs correctly to get rid of the carbon dioxide and exchange it for oxygen. RR is an early indicator of cardiac arrest when an individual suddenly collapses with abnormal or absent breathing.

The data receiving module 502 receives raw data from the 4 sensors carried by the user. The fuzzy classifier 504 uses a fuzzy classification table corresponding to each vital sign to assign a fuzzy set to the raw data corresponding to the each vital sign. For example, for the raw data from BP sensor, the fuzzy classifier 504 uses the fuzzy classification table 402. Similarly, for the raw data from HR sensor, the fuzzy classifier 504 uses the fuzzy classification table 404.

Thereafter, the rule-based processor 506 combines the fuzzy sets for all the 4 vital signs using the rules table 406 to determine severity level of the health condition of the user.

Finally, the alerting module 508 generates required alerts based on the severity level. The alert may be sent to the user herself, to the family members of the user, to the friends of the user, and to a caregiver such as a physician or other medical technician. Accordingly the caregiver may prescribe a remedy, may schedule a doctor's appointment, or may ask the user to visit the emergency room. In extreme cases, the caregiver may immediately schedule a 911 emergency response.

When an alert event is detected, it could trigger further downstream processing such as running average, linear regression analysis, trend analysis and recording for post analysis.

Further, an alarm may be raised when a pre-set threshold value for the individual sensor is crossed. Many of these alarms are of short duration and may return to normal range within seconds. Examples are short duration, low oxygen saturation, or heart rate alarms. By applying a delay of 15 to 20 seconds before an alarm is raised, the occurrence of false alarms is significantly reduced.

Yet further, status alerts are sent in case of signal quality issues, equipment malfunction or loss of contact of a sensor with the user's body.

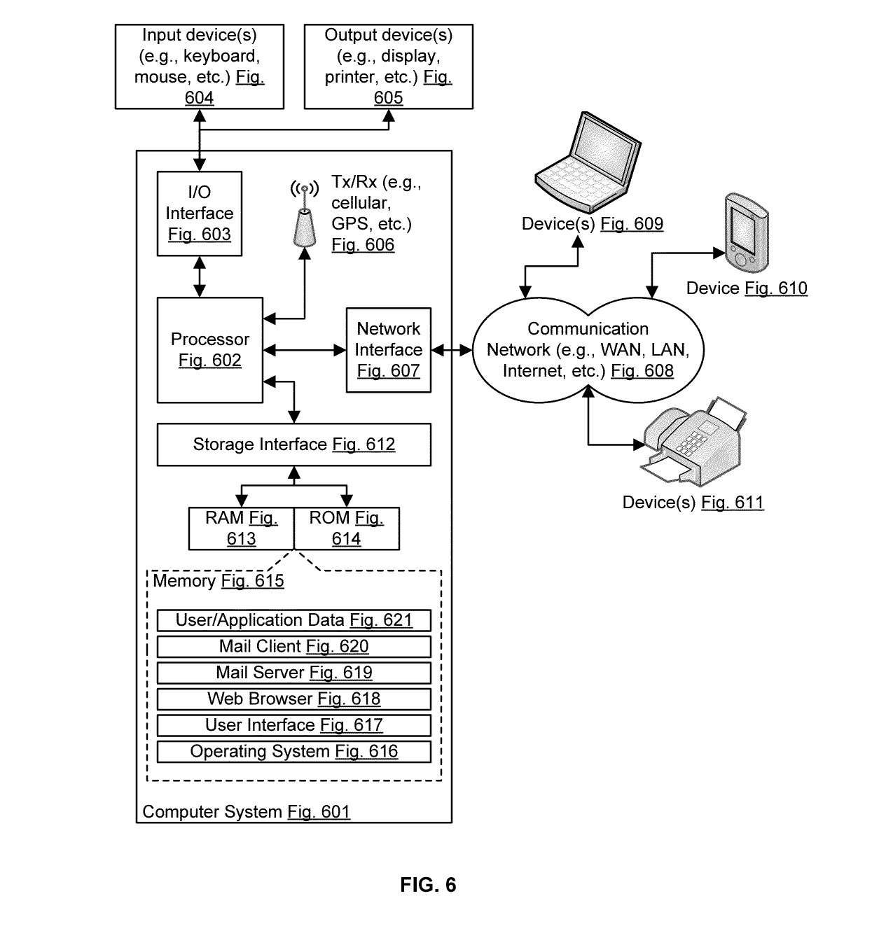

Referring now to FIG. 6, a block diagram of an exemplary computer system 601 for implementing embodiments consistent with the present disclosure is illustrated. Variations of computer system 601 may be used for implementing system 102 (the cloud server 102). Computer system 601 may comprise a central processing unit (“CPU” or “processor”) 602. Processor 602 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver may facilitate various types of wireless transmission or reception.

For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices 615 may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetB SD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. (e.g., keywords, requirements, test cases, test scripts, sub requirements, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

We claim:

1. A computer system for monitoring health condition of a user, comprising:
a cloud server computer configured to:
receive at least two sets of raw data from at least two sensors carried by the user;
process the at least two sets of raw data using a fuzzy set classifier to obtain a fuzzy set corresponding to each of the at least two sets of raw data;
combine the fuzzy sets corresponding to the at least two sets of raw data using a rule based processor to determine severity level for the user; and
send an alert based on the determined severity level.

2. The system of claim 1, wherein the at least two sensors include sensors embedded in smartphones, Personal Digital Assistants (PDA), smart watches, and wearable electronic devices.

3. The system of claim 1, wherein the health condition is a heart condition.

4. The system of claim 1, wherein the at least two sensors include sensors configured to sense vital signs of the user, wherein the vital signs include blood pressure (BP), blood oxygen saturation level (SpO2), respiration rate (RR), and heart beat rate (HR).

5. The system of claim 1, wherein the fuzzy set classifier processes the raw data received from a sensor to provide a corresponding fuzzy set based on a fuzzy set classification table, wherein the fuzzy set classification table includes predefined range of values of the raw data corresponding to the one or more fuzzy sets.

6. The system of claim 5, wherein a caregiver uses a user interface to predefine the range of values corresponding to the one or more fuzzy sets, wherein the caregiver determines the range of values based on at least one of a user's medical record and user's baseline record.

7. The system of claim 6, wherein a user's baseline record is established by continuously recording data from a sensor for specific time duration.

8. The system of claim 1, wherein the rule based processor combines the fuzzy sets corresponding to the at least two sets of raw data based on a rules table, wherein the rules table defines combinations of various fuzzy sets and corresponding severity levels.

9. The system of claim 1, wherein the sending alert includes providing different alerts based on the determined severity level.

10. The system of claim 9, wherein the different alerts include alerting specific caregivers and launching required clinical and operational processes.

11. The system of claim 1, wherein a user configures at least one alert parameter including alarm tones and designated alert receivers based on the determined severity level.

12. The system of claim 1, wherein a delay is applied for a short duration alarms of the at least two sensors.

13. The system of claim 1, wherein the raw data and processed data are formatted and stored for system interoperability.

14. The system of claim 13, wherein the raw data and the processed data is formatted according to HL7 standard.

15. A method for monitoring health condition of a user, comprising:
receiving, via a processor, at least two sets of raw data from at least two sensors carried by the user;
processing, via a processor, the at least two sets of raw data to obtain a fuzzy set corresponding to each of the at least two sets of raw data;
combining, via a processor, the fuzzy sets corresponding to the at least two sets of raw data to determine severity level for the user; and
sending, via a processor, an alert based on the determined severity level.

16. The method of claim 15, wherein the health condition is a heart condition, wherein the at least two sensors include sensors configured to sense vital signs of the user, wherein the vital signs include blood pressure (BP), blood oxygen saturation level (SpO2), respiration rate (RR), and heart beat rate (HR).

17. The method of claim 15, wherein the receiving further comprises obtaining, via a processor, the at least two sets of raw data from the at least two sensors via Internet.

18. The method of claim 15, wherein the processing further comprises using, via a processor, a fuzzy set classification table to provide a fuzzy set corresponding to the raw data received from a sensor, wherein the fuzzy set classification table includes predefined range of values of the raw data corresponding to the one or more fuzzy sets.

19. The method of claim 18, wherein the combining further comprises using, via a processor, a rules table to merge the fuzzy sets, wherein the rules table defines combinations of various fuzzy sets and a corresponding severity level.

20. The method of claim 15, wherein the sending alert includes providing, via a processor, different alerts based on the determined severity level.
